(19) United States
(12) Patent Application Publication
(10) Pub. No.: US 2015/0292173 A1
(43) Pub. Date: Oct. 15, 2015

(54) MARITIME FENDER AND ASSOCIATED METHOD OF MAINTENANCE

(71) Applicant: Scott Smith, River Valley (SG)

(72) Inventor: Scott Smith, River Valley (SG)

(73) Assignee: TRELLEBORG MARINE SYSTEMS AUSTRALIA PTY LTD, Sydney (AU)

(21) Appl. No.: 14/414,092

(22) PCT Filed: Jul. 11, 2012
(86) PCT No.: PCT/AU2012/000832

§ 371 Date: May 21, 2015

(51) Int. Cl. E02B 3/26; B23P 6/00

(52) U.S. Cl. CPC E02B 3/26; B23P 6/00

(57) ABSTRACT

The present disclosure provides a maritime fender assembly for mounting to a berthing structure, the fender assembly including: a panel assembly including an outwardly facing wear pad for contact with a vessel; a frame for releasably receiving the panel assembly; a resilient fender element mounted between the frame and the berthing structure; and an engagement means to allow engagement and disengagement of the panel assembly from the frame to allow removal and replacement of the panel assembly. The present disclosure also provides a maritime fender assembly comprising a frame carrying an outwardly facing wear pad, the frame including at least one frame-side support chain mount and at least one frame-side detensioner mount; a base mounted to the berthing structure, the base including a base-side support chain mount and a base-side detensioner mounts; a resilient fender element mounted between the frame and base; and support chains connected to a base-side support chain mount and a corresponding frame-side support chain mount, wherein the frame-side detensioner mount and base-side detensioner mount include a corresponding pair of detensioner mounts, the corresponding pair of detensioner mounts positioned to connect a detensioner between, the detensioner actuable to detension at least one support chain. The present disclosure also includes methods of maintaining such maritime fender assemblies.

### FIELD OF THE INVENTION

The present invention generally relates to maritime fenders for use on wharves. There is also disclosed a system and method of maintaining maritime fenders.

### BACKGROUND OF THE INVENTION

Maritime fenders are used to prevent damage of objects in or close to the water. Berthing structures (e.g. piers, docks, jetties etc) may have outwardly facing fenders to absorb impact between a vessel and the berthing structure.

Typically, fenders are constructed, at least in part, of resilient materials to absorb kinetic energy from the vessel. Fenders also generally include outwardly directed facing elements for contacting berthing vessels. Such facing elements are generally constructed of a material that will not damage the hull of berthing vessels, such as elastomeric rubber or rubber like materials. With use, fender facing elements are sacrificially worn and eventually require repair or replacement. During maintenance of the fenders, the berth becomes temporarily inoperable. For major port facilities, this downtime results in vessels unable to load/unload cargo which can be very costly.

In berthing facilities for large shipping vessels, the fenders may be constructed of multiple components including: a main rubber unit attached to the berthing structure for absorbing kinetic energy from the vessel; a frame attached to the main rubber unit opposite to the berthing structure; and outwardly facing wear pads attached to the frame for contact with vessel hulls. A chain system may be included to support the other components of the fender in position. In use, the chains may be taut (i.e. under tension) to ensure the components of the fender are kept in the desired position and orientation.

It would be desirable to provide fender maintenance methods and/or fender systems which reduce port/berth downtime. In addition, or in the alternative, it would be desirable to provide the public with a useful alternative to existing fender maintenance methods and/or fender systems.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

According to a first aspect, the present invention provides method of maintaining a maritime fender assembly mounted to a berthing structure, the maritime fender assembly comprising: a panel assembly including at least one outwardly facing wear pad for contact with a vessel; a frame for releasably receiving the panel assembly; a resilient fender element mounted between the frame and the berthing structure, the resilient fender element for absorbing forces on the panel assembly and/or frame; and an engagement means having a release configuration whereby the panel assembly is removable from the frame and an engaged configuration whereby the panel assembly is secured to the frame, wherein the method includes: configuring the engagement means to the release configuration; removing the panel assembly from the frame; replacing the panel assembly with a serviceable panel assembly; and configuring the engagement means to the engaged configuration to secure the serviceable panel assembly to the frame, wherein the method is performed while the frame and fender element are maintained in situ mounted to the berthing structure.

According to a second aspect, the present invention provides a method of maintaining a maritime fender assembly mounted to a berthing structure, the maritime fender assembly comprising: a frame carrying at least one outwardly facing wear pad for contact with a vessel, the frame including at least one frame-side support chain mount and at least one frame-side detensioner mount; a base mounted to the berthing structure, the base including at least one base-side support chain mount and at least one base-side detensioner mounts; a resilient fender element mounted between the frame and base; and one or more support chains connected to and extending between a base-side support chain mount and a corresponding frame-side support chain mount, wherein the method includes: affixing a detensioner between a frame-side detensioner mount and a corresponding base-side detensioner mount; activating the detensioner to draw the frame and base together, thereby detensioning a support chain, removing the detensioned support chain from its respective frame-side and base-side support chain mounts; affixing a serviceable support chain to the respective frame-side and base-side support chain mounts; deactivating the detensioner; and removing the detensioner from its frame-side and base-side detensioner mounts.

In another aspect, the present invention provides a maritime fender assembly for mounting to a berthing structure, the fender assembly including: a panel assembly including at least one outwardly facing wear pad for contact with a vessel; a frame for releasably receiving the panel assembly; a resilient fender element mounted between the frame and the berthing structure, the resilient fender element being for absorbing forces on the panel assembly and/or frame; and an engagement means having a disengaged configuration whereby the panel assembly is removable from the frame and an engaged configuration whereby the panel assembly is secured to the frame.

In yet another aspect, the present invention provides a maritime fender assembly for mounting to a berthing structure, the maritime fender assembly comprising: a frame carrying at least one outwardly facing wear pad for contact with a vessel, the frame including at least one frame-side support chain mount and at least one frame-side detensioner mount; a base mounted to the berthing structure, the base including at least one base-side support chain mount and at least one base-side detensioner mounts; a resilient fender element mounted between the frame and base; and one or more support chains connected to and extending between a base-side support chain mount and a corresponding frame-side support chain mount, wherein the at least one frame-side detensioner mount and at least one base-side detensioner mount include at least one corresponding pair of detensioner mounts, the or each corresponding pair of detensioner mounts positioned to connect a detensioner between, the detensioner actuable to detension at least one support chain.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1A is a front perspective view of a maritime fender assembly with a removable access platform;

FIG. 1B is a front perspective view of the maritime fender assembly;

FIG. 2 is a perspective view of the maritime fender assembly with a panel assembly partially removed;

FIG. 3 is a perspective view of the maritime fender assembly with one panel assembly completely removed;

FIG. 4 is a close up perspective view of the top corner of the maritime fender assembly showing details of the upper portion of the panel assembly and frame;

FIG. 5 is a similar perspective view of the maritime fender assembly shown in FIG. 4 with the top cover removed and illustrating a bracket assembly;

FIG. 6 is a similar perspective view of maritime fender assembly shown in FIG. 5 with a part of the bracket assembly removed;

FIG. 7 is a top view of the maritime fender assembly as shown in FIG. 6;

FIG. 8A is a side view of the maritime fender assembly shown in FIG. 1B;

FIG. 8B is a front view of the maritime fender assembly shown in FIG. 1B;

FIG. 8C is a top view of the maritime fender assembly shown in FIG. 1B;

FIG. 9A is a perspective view of the removable access platform;

FIG. 9B is a perspective view of a gangway for the removable access platform;

FIG. 10A is a front view of the panel assembly;

FIG. 10B is a front perspective view of the panel assembly;

FIG. 10C is a cross-section of the panel assembly of FIG. 10A along section A-A

FIG. 11A is a front view of a panel plate of the panel assembly shown in FIG. 10A;

FIG. 11B is a side view of the panel plate shown in FIG. 11A;

FIG. 11C is a cross-section of the panel plate shown in FIG. 11A along section A-A;

FIG. 11D is a close up view of detail B shown in FIG. 11B;

FIG. 11E is a close up view of detail C shown in FIG. 11B;

FIG. 12A is a front view of a plurality of wear pads of the panel assembly shown in FIG. 10A;

FIG. 12B is a front view of the lower left wear pad shown in FIG. 12A;

FIG. 12C is a top view of the wear pad in FIG. 12B;

FIG. 12D is a cross-section of the wear pad of FIG. 12B along section A-A;

FIG. 12E is a cross-section of the wear pad of FIG. 12B along section B-B;

FIG. 13A is a front view of a frame body of the frame;

FIG. 13B is a cross-section of the frame shown in FIG. 13A along section A-A;

FIG. 13C is a cross-section of the frame shown in FIG. 13A along section B-B;

FIG. 13D is a cross-section of the frame shown in FIG. 13A along section C-C;

FIG. 14A is a front view a plurality of inner wear pads of the frame;

FIG. 14B is a cross-section of the plurality of inner wear pads in FIG. 14A along section A-A;

FIG. 14C is a close up view of detail B shown in FIG. 14B;

FIG. 14D is a cross-section view of a portion of the frame, showing fasteners securing the inner wear pad to the frame body;

FIG. 15 is a top view of a detensioning chain;

FIG. 16 is a flow chart depicting the steps involved in removing a panel assembly;

FIG. 17 is a flow chart depicting the steps involved in maintaining a panel assembly;

FIG. 18 is a flow chart depicting the steps involved in replacing a panel assembly;

FIG. 19 is a flow chart depicting the steps involved in maintaining one or more support chains.

### DETAILED DESCRIPTION OF THE EMBODIMENTS

Embodiments of the present invention are directed to systems and methods for maintaining maritime fender systems. In the below, and overview of a fender system and maintenance method in accordance with an embodiment of the invention will be provided, before providing a more detailed description of the physical structure of a fender system according to an embodiment of the invention and a method for maintaining a fender system according to an embodiment to the invention.

### Overview

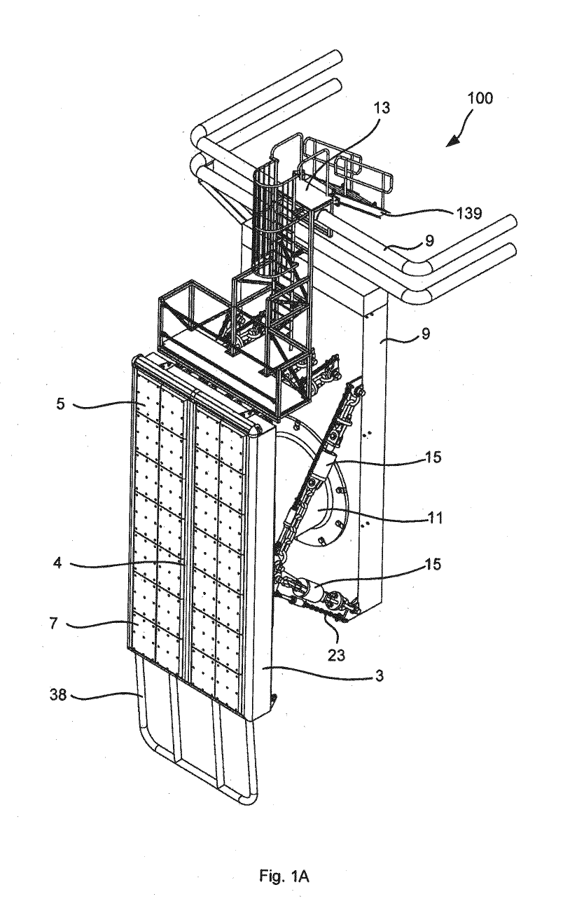

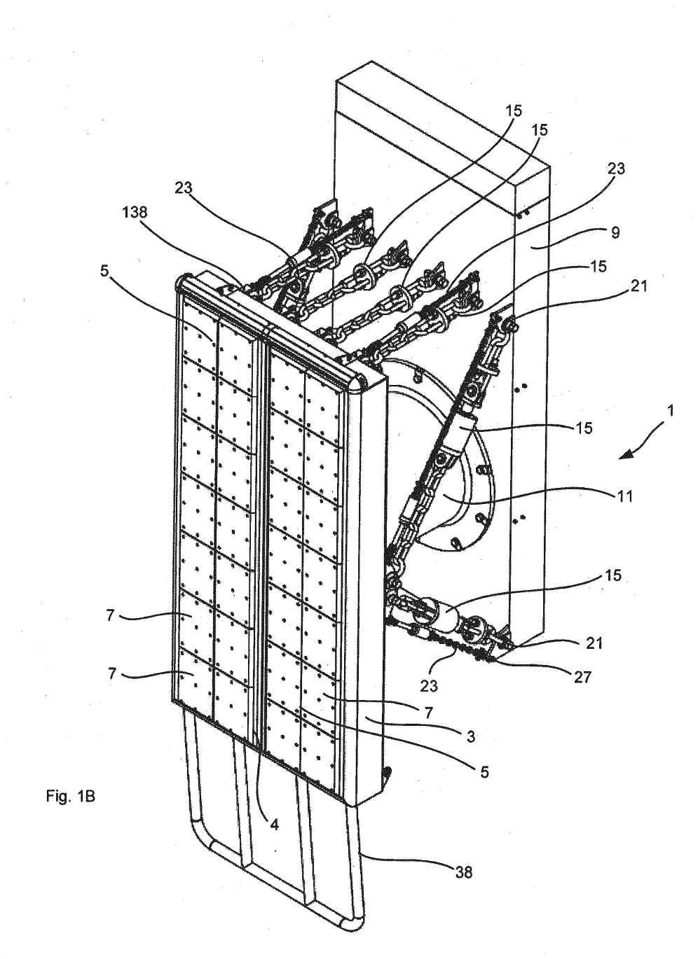

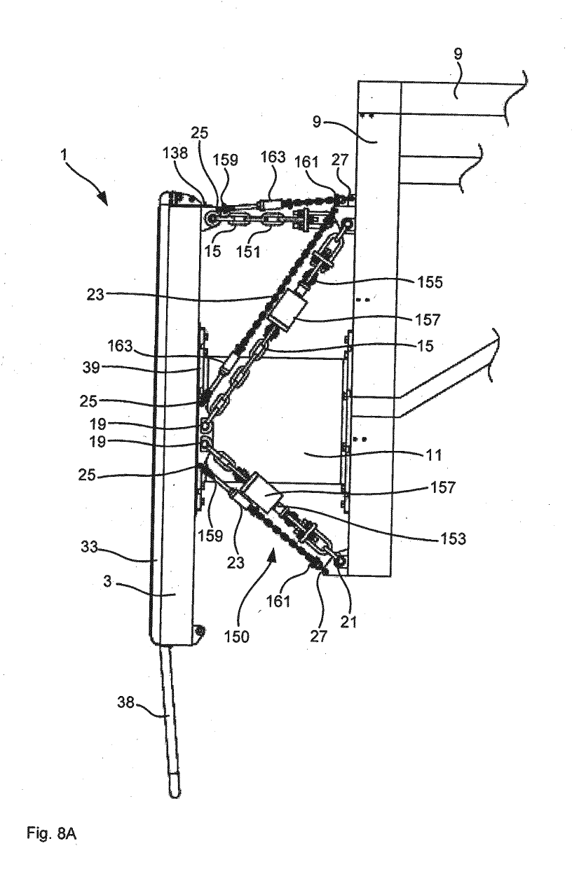

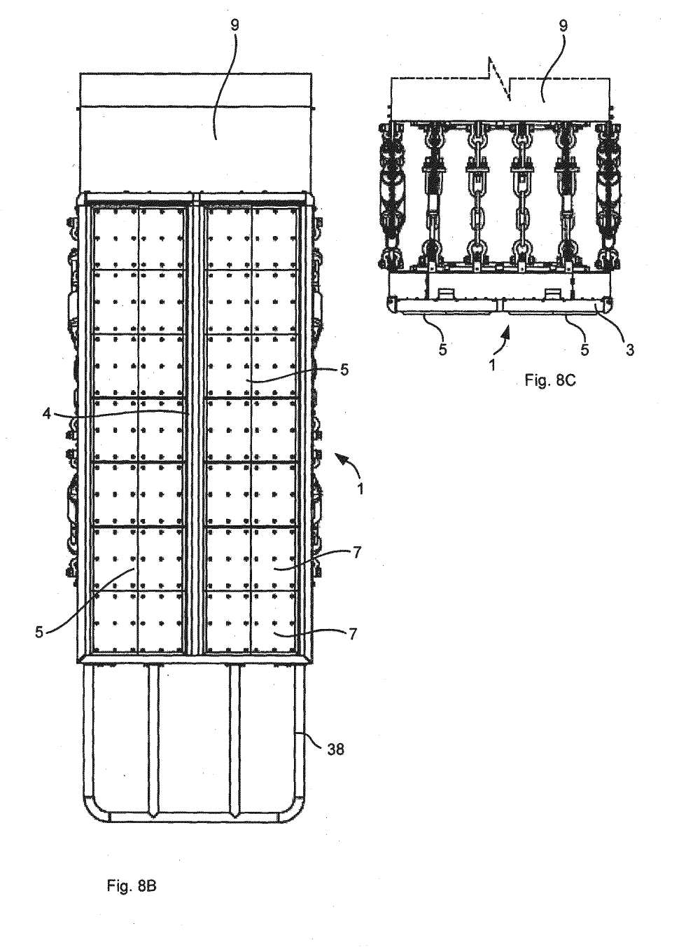

FIGS. 1A, 1B, 8A, 8B and 8C illustrates a maritime fender assembly 1 for a berthing structure (not shown), such as a pier, wharf, jetty, dolphin structure, goods terminal, passenger terminal etc.

The fender assembly 1 has a frame 3 which releasably receives removable panel assemblies 5 via engagement means 4.

The frame 3 is mounted via an energy absorbing fender element 11 to a base 9 which in turn is fixed to the berthing structure. Fender element 11 allows the frame 3 to move relative to the base 9 and berthing structure when impacted by berthing vessels. In use, outwardly facing wear pads 7 on the panel assemblies 5 provide a contact surface for a hull of a vessel, and kinetic energy from impact of the hull is transmitted to the frame 3 and absorbed by the fender element 11.

For maintenance, the panel assemblies 5 are disengaged from the frame 3 to allow for their removal for servicing and/or replacement. This can be done while the remaining parts of the fender assembly 1, such as the frame 3, fender element 11 and base 9 are maintained in situ.

The fender assembly 1 is also provided with a plurality of support chains 15, each support chain extending between mounting points such as 19 and 21 respectively located on the frame 3 and base 9. The support chains 15, in use, are positioned and tensioned to maintain the frame assembly 3 (and the panel assemblies 5 carried thereby) in a selected position and/or orientation. To assist in maintenance of the fender assembly 1, there is also disclosed a detensioning system 150 for detensioning the support chains 15 to allow for their removal for replacement or other maintenance. The detensioning system 150 includes one or more detensioning chains 23 that are mountable adjacent to the support chain mounting points 19, 21 via first and second detensioner mounting points 25 and 27 provided respectively on the frame 3 and base 9. When the support chains 15 need to be removed, detensioning chains are secured in place between the detensioner mounting points and then shortened to relieve tension in the support chain 15.

To further assist in the maintenance procedure additional components and assemblies may also be used. For example, in FIG. 1 a removable access platform 13 is shown. Platform 13 is removably located at the fender assembly and secured to the berthing facility to provide a working area for workers to access relevant components, of the fender assembly 1.

It will be appreciated that embodiments of the present invention extend to individual components/assemblies that are described herein, as well as to various combinations of those components/assemblies. Further, while in the illustrated embodiments of the invention the fender assembly 1 is shown with two panel assemblies, the invention could equally be practiced with a single panel assembly or more than two panel assemblies.

### Fender Assembly

The components of the fender assembly 1 will now be described in detail.

### Frame

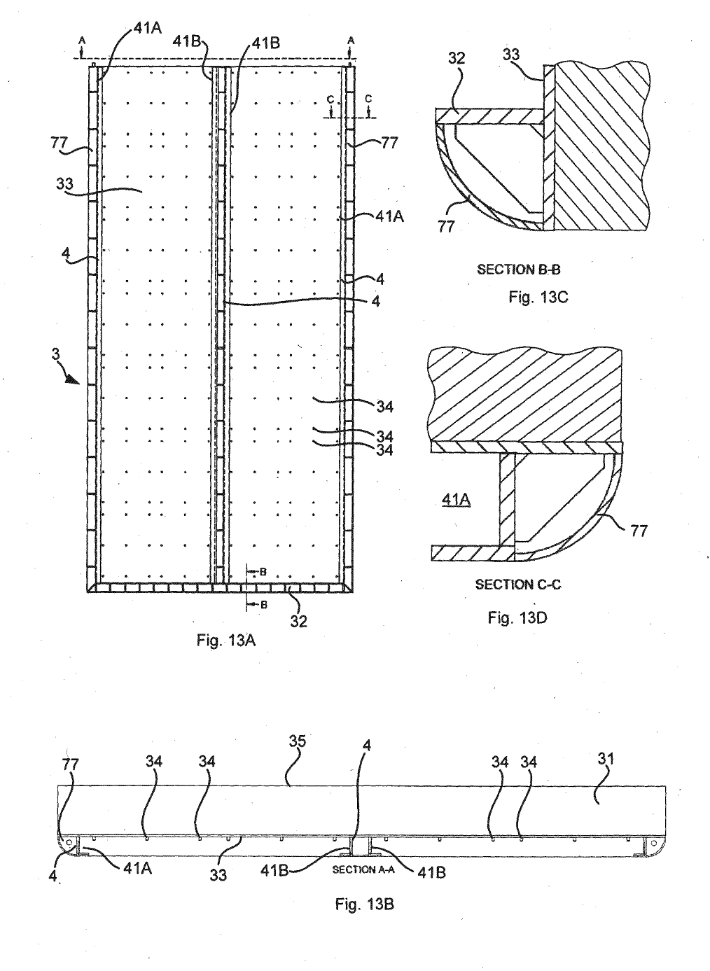

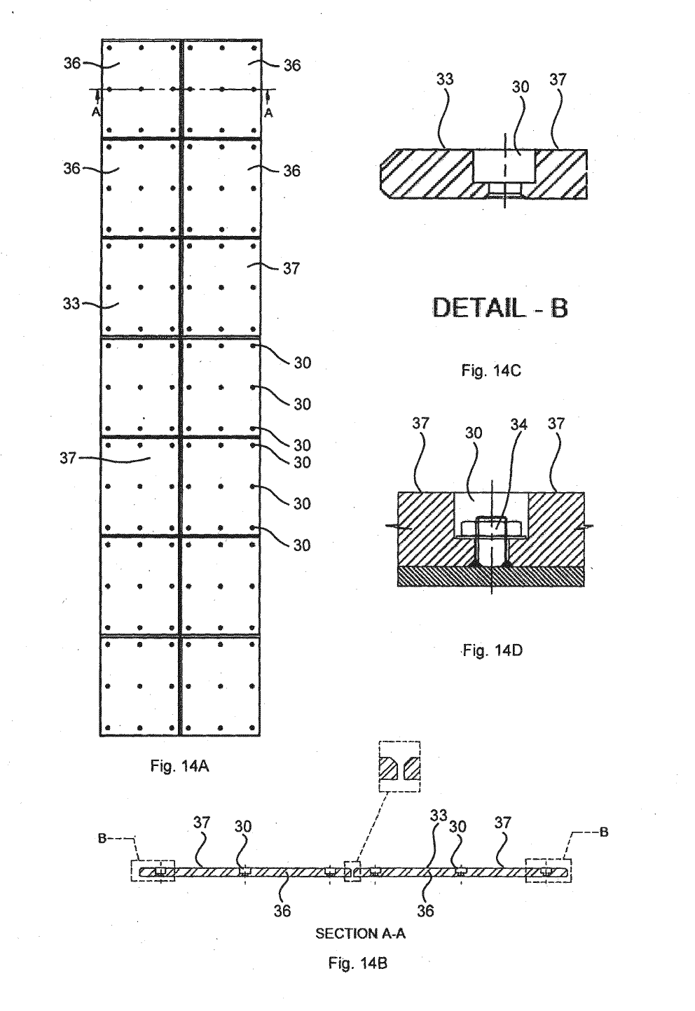

The frame will now be described with reference to FIGS. 13A-14D.

The frame 3 has a substantially hollow rectangular prism frame body 31 constructed from stainless steel or other material suitable for use in a marine environment. The frame body 31 has two main planar surfaces on opposite faces: an outwardly facing surface 33 facing away from the berthing structure, and an inwardly facing surface 35 facing towards the berthing structure.

The outwardly facing surface 33 is provided with a low friction surface 37 , which provide a low friction surface for panel assemblies 5 to slide against during removal and replacement, as well as an abutment surface for transmission of an impact force from the panels 5 to the frame 3. In this instance the low friction surface 37 is provided by a plurality of inner wear pads 36 arranged into two arrays separated by the central channels 41B as discussed below with reference to FIGS. 14A-14D. Each inner wear pad 36 is made of UHMWPE or HDPE and has a plurality of apertures 30 for affixing the inner wear pad 36 to the frame 3 by fasteners 34, as shown in FIG. 14D. As illustrated, M16 SS316 studs are welded to the frame 3. Subsequently M16 SS316 half-nuts and oversized washers are used to the inner pads to the studs/frame 3. Advantageously, though not essentially, the low friction surface 37 (e.g. the individual inner wear pads 36) may be coloured to contrast with other components of the fender assembly 1, and in particular with the colour of the outwardly facing wear pads 9. This assists in easy visual identification of a fender assembly 1 which is undergoing maintenance and has a panel 5 removed.

The inner wear pads 36 may be replaced periodically due to the frictional wear or change from contact with the panel assemblies 5. However this will generally be less frequent then replacement of the outwardly facing wear pads 7.

At the centre of the inwardly facing surface 35 is a frame assembly mount 39, where the frame 3 is mounted to the fender element 11. The frame assembly mount 39 provides the interface for transmission of force and energy from the frame 3 to the fender element 11.

As can most easily be seen in FIG. 8A, the inwardly facing surface 35 of the frame 3 is also provided with a plurality of support chain mounting points 19, each with respective adjacent detensioner mounting points 25.

At the top portion of the frame 3, there is a plurality of vertically extending spigots 138, best shown in FIG. 1B and 8A. These spigots 138 are received in apertures 136 of the removable access platform 13, which will be described in more detail below.

A rope guard 38 extends from the lower portions of the frame body 31 to prevent entanglement of mooring lines with the fender assembly 1.

### Engagement Means

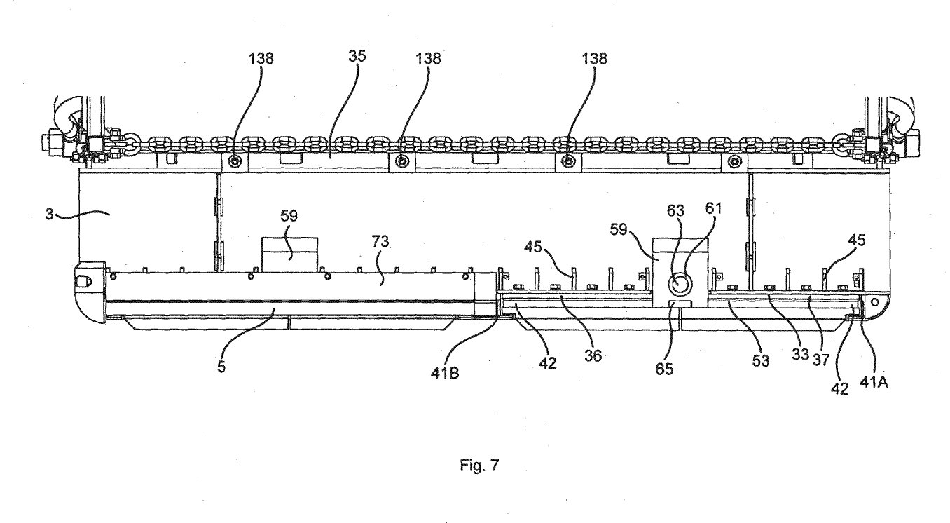

In order to removably receive the panel assemblies 5 (discussed below), the frame 3 is provided with two pairs of opposing channels 41, best seen in FIG. 7. Each pair of opposing channels 41 includes an edge channel 41A disposed proximate to a vertical side edge of the frame 3, and a relatively central channel 41B running down the frame 3. Each edge channel 41A runs substantially the length of the frame 3 and opens towards its associated central channel 41B. Each central channel 41 B also runs the substantial length of the frame 3 and opens towards its associated edge channel 41A. At the base of the frame 3 is an outwardly extending lip 32 for abutting against and supporting the panel assemblies 5 when in place.

In use, the channels 41 and lip 32 form part of the engagement means 4. Each pair of opposing channels 41 is adapted to receive a pair of opposite side edges 42 of a panel assembly 5 which slots into place in the channels 41 and rests on the lip 32.

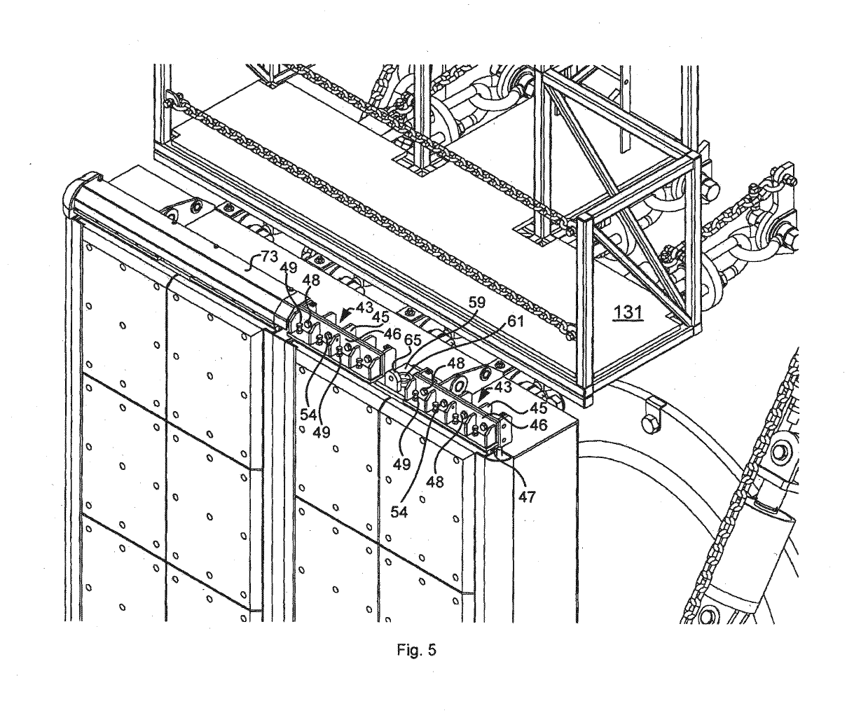

In order to secure the panel assembly 5 in place a bracket assembly 43 is used as best illustrated in FIG. 5. The bracket assembly includes a first bracket 45 fixed to the top portion of the frame body 31. The first bracket 45 is provided with a plurality of fastening apertures 52 to enable fasteners (e.g. bolts 48) to pass through. The bracket assembly also includes a second bracket 46 having a plurality of fastening apertures 54 corresponding to the fastening apertures 52 of the first bracket 45. Removable bracket 46 further includes a panel assembly abutment surface 47 for abutment with a top portion 57 of a panel assembly 5. The vertically oriented bolts 49 are received into the removable brackets 46 via threaded apertures. The bolts 49 then tightened sufficiently to push against the top portion 57 of the panel assembly 5. This force prevents the panel assemblies 5 from popping out of the channels 41 of the frame 3. When the bracket assembly 43 is assembled by fastening the brackets together, the panel abutment surface 47 prevents the panel assembly 5 from slidingly moving out of engagement with the frame 3.

The bracket assembly 43 in this embodiment, forms a further part of the engagement means 4.

In use the bracket assembly 43 secures a panel assembly 5 in place by fastening the removable bracket 46 to the fixed bracket 45, whereby the panel assembly abutment surface 47 prevents the panel assembly 5 from moving out of place.

### Panel Assemblies

The panel assembly 5 will now be described with reference to FIGS. 10A-12E.

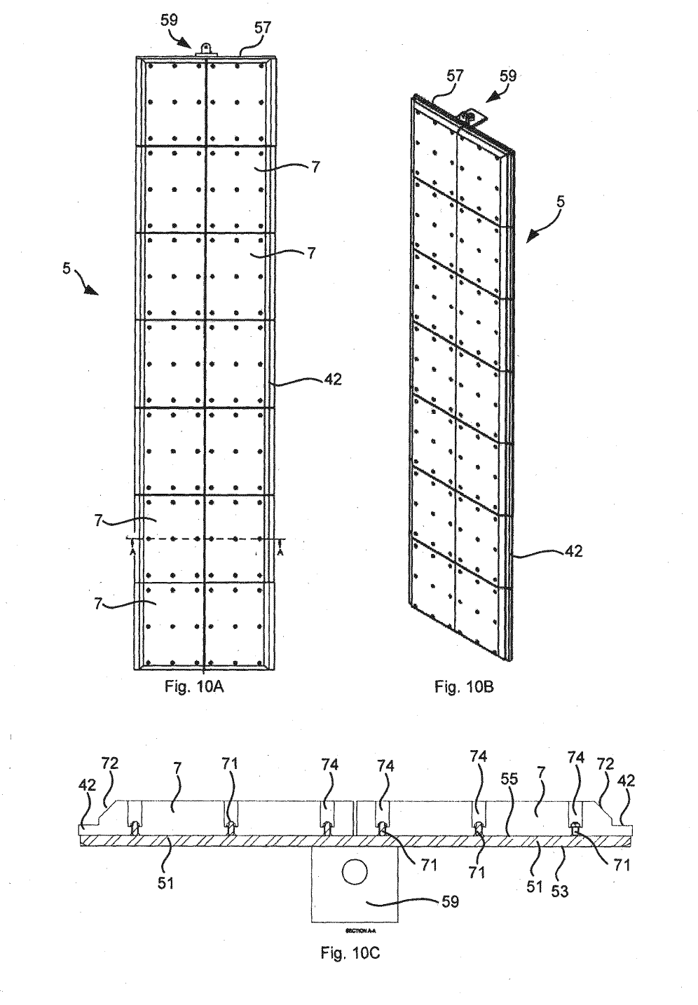

Each panel assembly 5 has a substantially flat panel plate 51 constructed of stainless steel as illustrated in FIGS. 11A-11E. The panel plate 51 has an inner surface 53, which when the panel assembly 5 is received by the frame 3 abuts the inner wear pads 37. The panel plate 51 has an outer surface 55 to which the fender face is affixed. In this embodiment the fender face includes an array of outwardly facing wear pads 7 which are releasably mounted to the plate 51 fasteners 71 (such as bolts and nuts) as shown in FIGS. 10C and 11C. At the opposite peripheral sides of the panels 5 are vertical side edges 42, which are slidingly receivable into the channels 41 along a vertical sliding axis along the channel to engage the panel 5 with the frame 3. The outwardly facing wear pads 7 includes an angled section 72 leading to the vertical side edges 42. This angled section 72 assists in guiding the vertical side edges 42 in to the channels 41 when sliding the panel assembly 5 into engagement with the channels. There is also a chamfer 68 on the lower left and right inward facing edges of the panels 5 as shown in FIG. 11B detail B and FIG. 11D. This further assists sliding the panel assembly into engagement with the channels 41. This chamfer extends approximately 2 metres from the bottom edge of each panel 5.

At the top 57 of the panel 5 a jacking bracket 59 is provided as best shown in FIGS. 11A, 11B and 11C. The jacking bracket 59 extends rearwardly from the panel so as, in use, to extend over a section of the frame 3. The jacking bracket 59 has an internally threaded aperture 61 having an aperture axis A which is parallel to the vertical sliding plane of the panel assembly 5 (i.e. the plane along which the panel is slid into receiving channels 41). The lower opening of the threaded aperture 61 faces a jack engagement surface 63 on the top portion of the frame body 31. The threaded aperture 61 allows a threaded rod/jack (not shown) to be received therein, whereby movement of the rod through the aperture 61 causes an end surface of the rod to impart a force against the jack engagement surface 63. The resulting force separates the jacking bracket 59 and the panel 5 away from the jack engagement surface 63 of the frame body 31 in a direction along the vertical sliding plane. This can be of assistance where the panel assembly 5 has become stuck in place in the frame 3 due to marine growth for instance.

A lifting lug 65 is provided at the top portion 57 of the panel 5, and in the illustrated embodiment, extends from the jacking bracket 59. The lifting lug 65 allows the panel assembly 5 to be attached to a hoist to lift the panel assembly 5 for extraction from and insertion into the fender assembly 1.

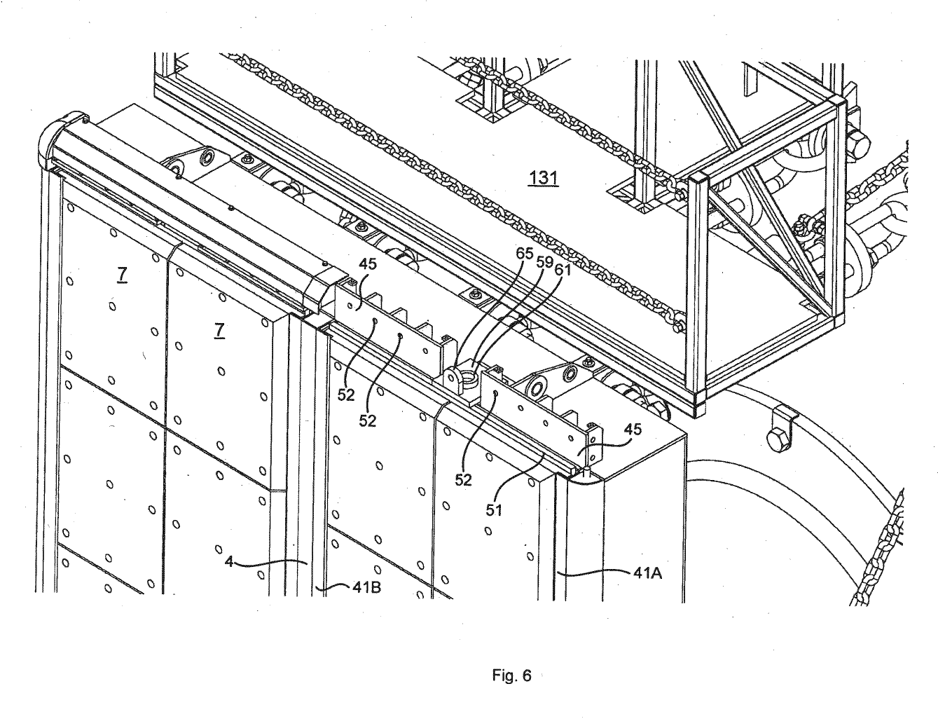

A stop 67 is provided to on the panel 5 to prevent downward vertical movement of the panel 5 beyond a desired position relative to the frame 3. The stop 67 may be a bottom surface of the jacking bracket 59, which, when the panel 5 is at the lowermost desired position is in abutment with the top portion of the frame body 31, as best illustrated in FIGS. 6 and 11E. The stop 67 is functionally similar to the lip 32 described above, and may also form part of the engagement means 4.

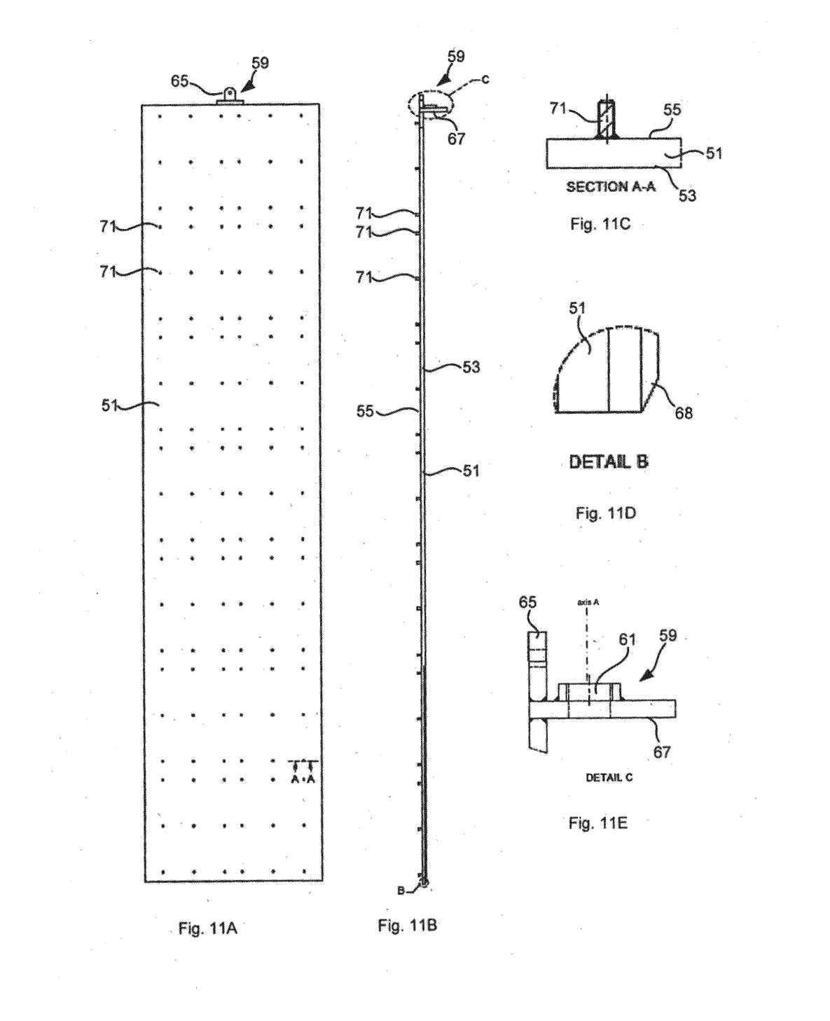

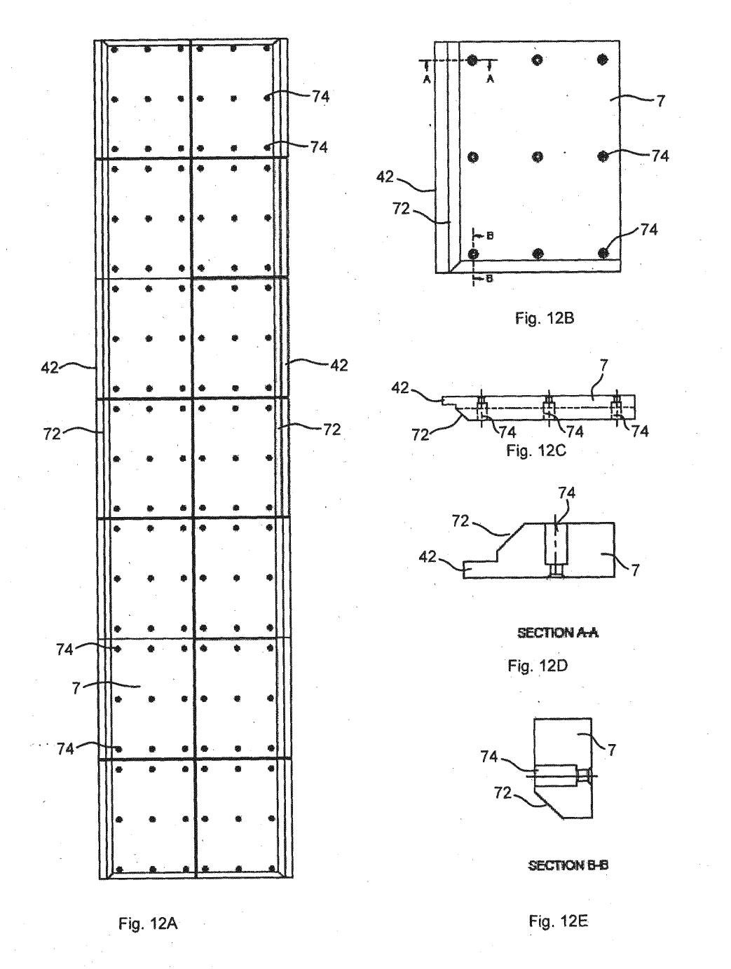

The outwardly facing wear pads 7 function as a sacrificial part of the fender assembly 1 as best shown in FIGS. 12A-12E. The outwardly facing wear pads 7 are made of a low friction material designed to avoid (as far as possible) damage to objects that are expected to bear against them, such as the hull of vessels. The outwardly facing wear pads 7 may be made of a plastic material such as Ultra-high-molecular-weight polyethylene (UHMW-PE) or HDPE. The wear pads 7 have a plurality of apertures 74 to receive fasteners 71 for securing the wear pads 7 to the panel plate 51.

### Fender Element

The fender element 11 of the present embodiment is a substantially hollow cylindrical form made of a resilient elastomeric material, such as rubber, such as SCN super cone fender or SCK super cell fender. These are the most commonly used fender types for large fender systems supplied by Trelleborg AB and come in a variety of sizes from 300 mmH to 3000 mmH. The fender element 11 is designed to absorb and cushion force, momentum and energy transmitted via the moveable frame 3 and panel assemblies 5. Typically this will be from an impact of the hull of a vessel to the panels 5. During impact, the fender element 11 deforms to allow movement of the frame 3 and panel assemblies 5. After impact, the resilience of the material allows the fender element 11 to rebound back to the pre-impact shape state.

In the illustrated embodiment, one end of the fender element 11 is attached to the mounting location 39 of the frame 3, and the opposite end attached to the base 9. At least part of the weight of the frame 3 and panels 5 in this embodiment is supported by the fender element 11 (the remainder of the weight being supported by support chains 15 as discussed below).

The fender element 11 also provides a bias force to the frame 3, which is countered by a reactive tension force in the support chains 15 discussed below. This bias force includes a component biasing the frame 3 outwardly away from the base 9.

### Base

The base 9 is fixed to the berthing structure, thus forming a “fixed” part of the fender assembly 1 relative to the berthing structure. This is in contrast to the “moveable” frame 3 and panel assemblies 5. The base 9 provides an attachment point for the fender element 11. The base also provides support chain mounting points 21 and detensioner system mounting points 27.

The base 9 as the “fixed” part of the fender assembly 1 also provides a stable support for the access platform 13 during maintenance,

### Guards

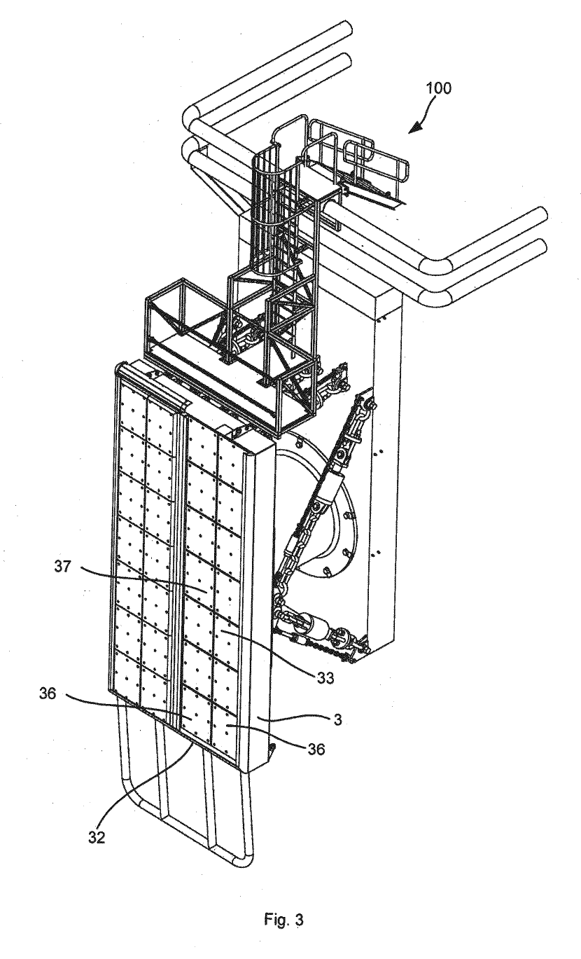

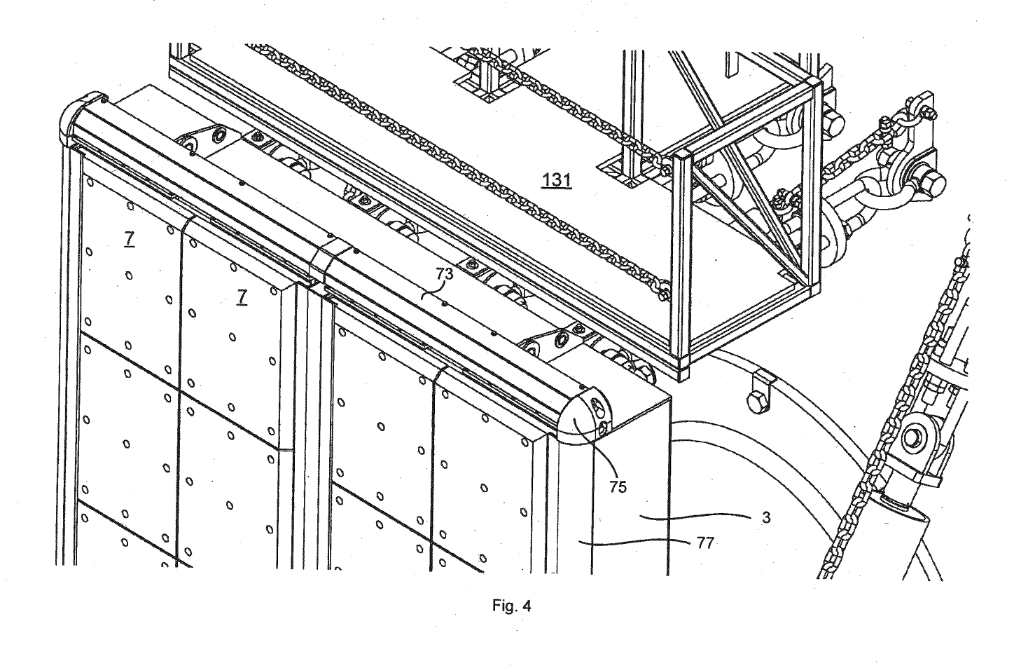

To prevent snagging of mooring lines, and damage from incidental impact, the fender 1 is provided with a series of bumper guards and covers as illustrated in FIG. 4. In this instance these include a top cover 73 over the bracket assembly 43, and rubber corner and edge protectors 75 and 77 for providing a bumper guard to protect the frame from vessel contact. These covers 73 and guards 75, 77 may be modular and replaceable.

As described above, a rope guard 38 is also provided below the fender to reduce the likelihood of mooring (or other) ropes/chains being caught behind the fender 1.

### Support Chains

A plurality of support chains 15 assist in maintaining the frame 3 and panel assemblies 5 in a desired position and orientation, and are normally under tension. The tension in the support chains 15 may be due to any one of weight of the frame 3 and panel assemblies 5, bias force of the energy absorbing means 11, or external forces acting on the frame 3 and panels 5 such as waves, wind or impact the hull of a vessel.

Tension chain 151, is a support chain 15 for maintaining the frame 3 in a substantially vertical orientation, in particular preventing the frame 3 and the outwardly facing wear pads 7 from facing downwards towards the water.

Uplift chain 153, is a support chain 15 for maintaining the frame 3 in a substantially vertical orientation, in particular preventing the frame and the outwardly facing wear pads 7 from displacing upwards during a vessel berthing operation.

Weight chain 155, is a support chain 15 for supporting the weight of the frame 3 and panels 5, to prevent the frame 3 and panel assemblies 5 from displacing downwards.

A component of the tension in the above described support chains 15 also assists in preventing the frame 3 and panel assemblies 5 from displacing outwards away from the base 9.

Shear chains (not shown) are another type of support chain 15 that may be used. Shear chains provide a tension force to prevent the frame 3 from rotating from side to side, and are typically arranged in a cross pattern when the fender assembly is viewed from the top.

The support chains 15 may also include a length adjustable element 157. The length adjustable element 157 allows adjustment of the desired length of the support chains 15 to achieved the desired position/orientation of the frame 3 and panel assemblies 5.

### Detensioning System

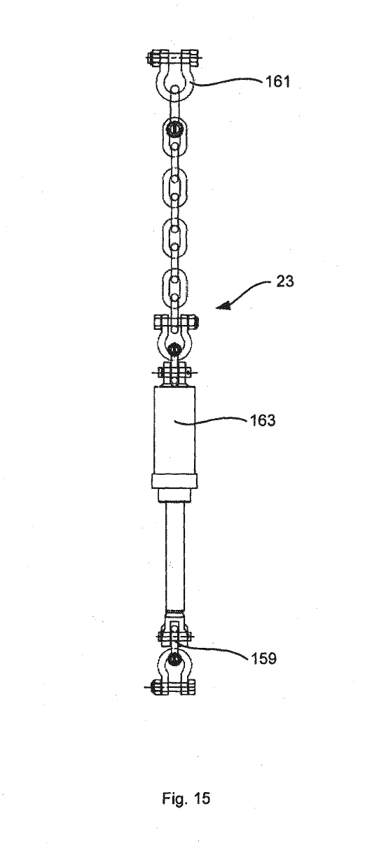

In order to facilitate simple and efficient maintenance of the support chains, one or more detensioning chains 23 are provided as best illustrated in FIGS. 8A, 8C and 15. Typically a plurality of detensioning chains are provided, one to match each support chain that needs to be detensioned.

Each detensioning chain has a first end 159 receivable to a frame-side detentioner mounting point 25, and a second end 161 receivable to the base-side detentioner mounting point 27. A length adjustable component 163 is disposed between the detensioner ends 159 and 161, and when activated, draws the ends 159 of the detensioner 161 together.

The length adjustable component 163 in one embodiment includes a hydraulic cylinder to provide force to pull the ends 159, 161 together. When deactivated, the hydraulic cylinder may slowly decrease the hydraulic force to allow the ends 159, 161, and attached components of the fender assembly 1 to be separated from each other in a controlled manner.

As described above, the frame-side and base-side detensioner mounting points 25 and 27 of the present embodiment are mounted adjacent to the relevant support chain mounting points. It will be appreciated, however, that alternative mounting points could be used provided their position allows the detensioner to detension the relevant support chain on operation.

Maintenance system

### Hoist

The maintenance system 100 for the fender assembly 1 includes a hoist (not shown). The hoist may be in the form of a crane or other machinery capable of lifting loads vertically. This may include a mobile crane driven or otherwise transported to the either the berthing assembly or water adjacent the fender assembly 1.

### Access Platform

To facilitate maintenance, and in particular worker access to the top of the fender frame 3, a removable access platform 13 may be provided.

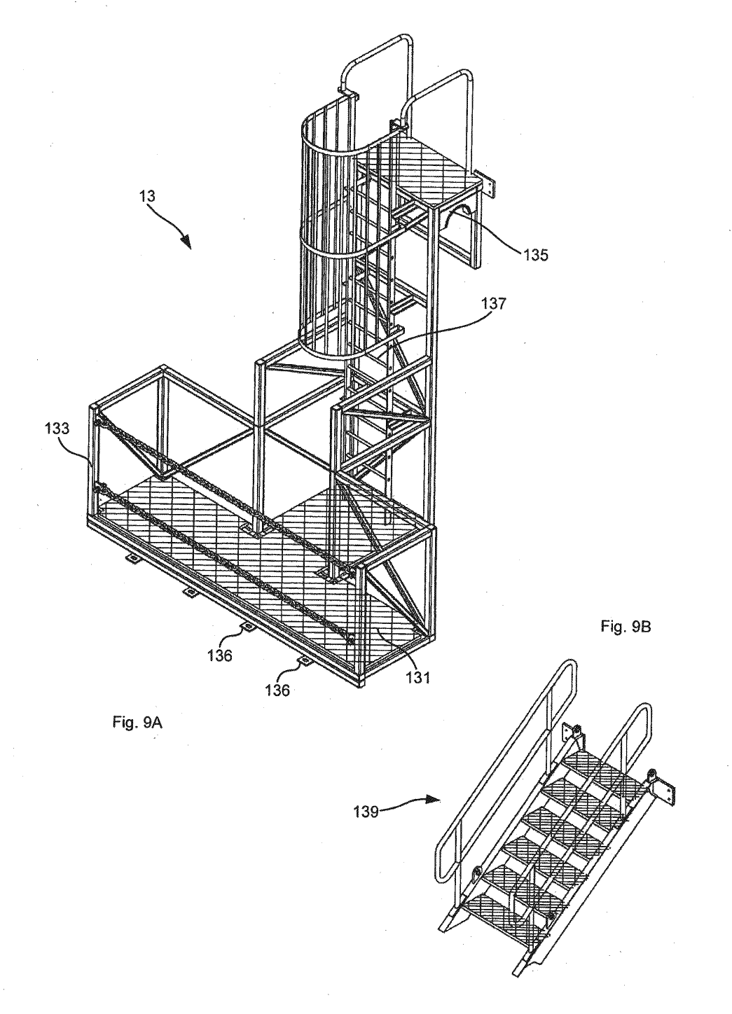

Referring to FIGS. 9A and 9B, the removable access platform 13 includes mounting zone 135 for locating the access platform 13 with the base 9 of the fender assembly 1. A working area 131 is provided at a level below the mounting zone 135, whereby the working area is accessible by a ladder 137. The working area 131 is located to provide access for workers to components of the fender assembly 1, including the lifting lug 65, jacking bracket 59 and bracket assembly 43. A safety barrier 133 surrounds the working area 131 and ladder 137. As shown in FIG. 9A, the removable access platform 13 is provided with a plurality of flanges each having respective apertures 136. The apertures 136 receive the corresponding spigot 138 extending upwardly from the frame 3. This ensures that the access platform 13, and the working area 131 is located correctly in the desired position relative to components of the fender assembly 1. This arrangement may also ensure stability of the access platform 13 and/or the frame 3 during maintenance operations.

A gangway 139 may be provided as a bridge between the access platform 13 and the pier.

By locating the mounting zone 135 of the access platform 13 with the base 9, movement of the moveable frame 3 or panel 5 will not affect the stability of the access platform 13. Advantageously, this provides a stable work area in contrast with attempting to access components of the fender assembly 1 from a vessel on the water.

### Method/Operation

In a port facility, berthing structures such as a pier have a plurality of fender assemblies 1 located at areas where vessels are expected to be berthed. After prolonged use of the pier, the wear pads 7 of the fender assemblies will wear and eventually require replacement. To ensure the fender assemblies are maintained in a serviceable condition, the wear pads 7 need to be inspected, and replaced if required.

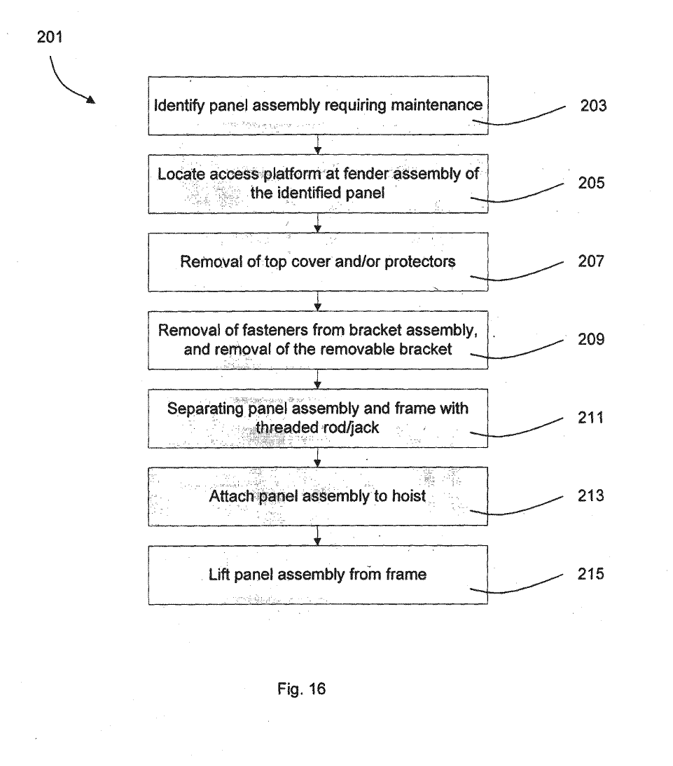

Maintenance of the fender assemblies 1 will now be described with reference to FIGS. 16-19 which show respectively: a flowchart 201 depicting the steps involved in removing a panel assembly 5; a flow chart 301 depicting the steps involved in maintaining a panel assembly 5; a flow chart 401 depicting the steps involved in replacing a panel assembly; and a flowchart 501 depicting the steps involved in maintaining one or more support chains 23.

Although the various steps/stages in FIGS. 16-19 are depicted sequentially, it will be understood that not all steps/stages will be necessary in all situations, and ordering the steps/stages as depicted is not (in all instances) essential.

### Removal of Panel Assemblies

The removal of the panel, assemblies will now be described with reference to FIG. 16.

At step 203 a fender assembly having a panel assembly 5 that requires maintenance is identified. Identification of the panel assembly 5 may be in accordance with a maintenance schedule and cycle, whereby panel assemblies 5 (or, more particularly, the outwardly facing wear pads 7 carried thereby) are periodically removed and inspected. Alternatively, the inspection of the plurality of the fender assemblies 1 and panels 5 in situ may result in identification of panels 5 that warrant removal and further inspection and/or servicing.

At step 205, and if being used, the access platform 13 is located at the fender assembly 1 of the identified panel assembly 5, as shown in FIG. 1A, by lowering the access platform 13 onto the base 9 with a hoist. This allows workers at the working area 131 to access components at the top portion of the frame 3 and panels 5.

Workers at the working area 131 may then begin the process of releasing the identified panel assembly 5 from engagement from the frame 3. This includes removal of the top cover 73, and corner protectors 75 from bracket assembly 43 at step 207 (as shown in FIGS. 4 and 5). At step 209 the fasteners 48 can then be removed, to allow removal of the removable bracket 46 from the bracket assembly 43 as shown in FIG. 6. At step 211 (if required), a threaded rod/jack (not shown) may then be rotated into threaded aperture 61, whereby the end surface of the rod imparts a force against the jack engagement surface 63. This resultant force separates the jacking bracket 59 and the attached panel assembly 5 away from the frame body 31 by a small distance, for example 50 mm. This advantageously assists to dislodge any marine growth than may impair easy separation between the panel assembly 5 and the frame 3. The jacking screw may be part of a hydraulic jack lowered by the hoist.

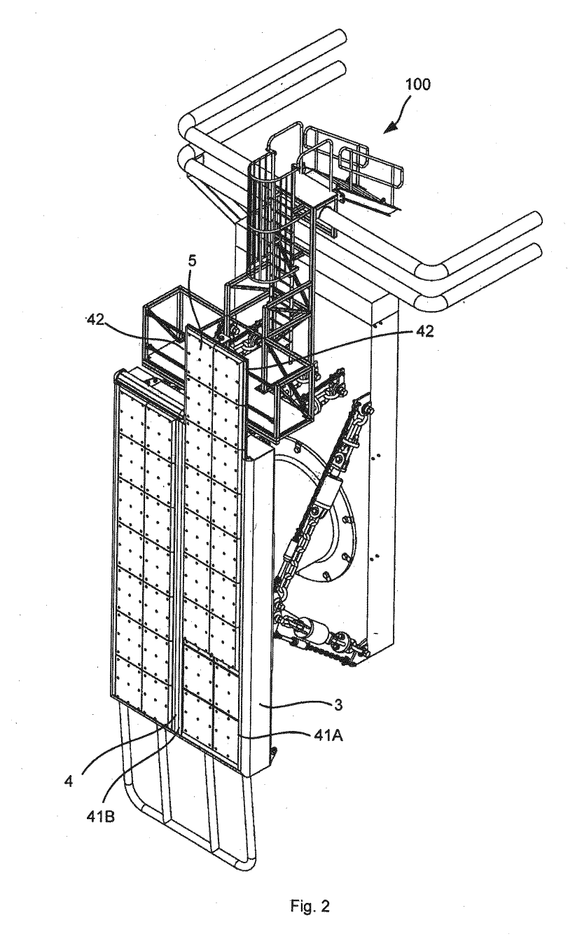

At step 213 the panel assembly 5 is then attached to the hoist via the lifting lug 65, and at step 215 the panel assembly 5 is lifted vertically from the frame 3. As the opposite side edges 42 of the panel assembly 5 are received in the opposing channels 41, panel assembly 5 has a guided path along a vertical sliding plane as it is slidingly disengaged from the frame 3, as best illustrated in FIG. 2.

### Maintenance of Panel Assembly

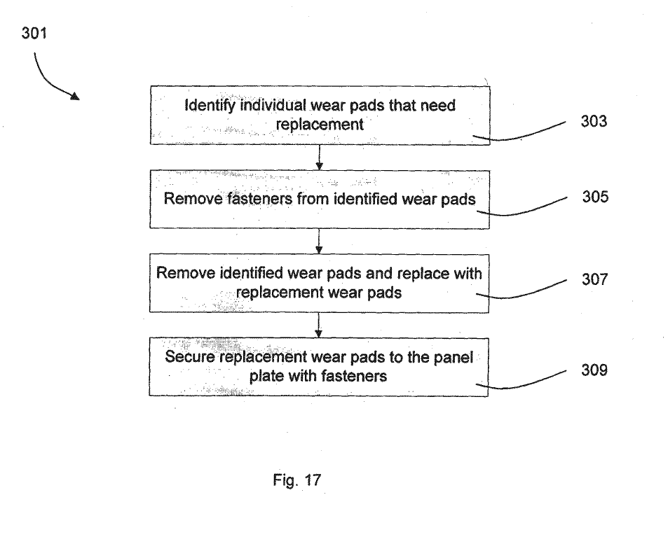

Turing to FIG. 17, once the panel assembly 5 is lifted clear of the remaining fender assembly 1, as shown in FIG. 3, it is moved away for inspection, servicing or destruction.

At step 303 the panel assemblies 5 are inspected to identify individual wear pads 7 that need replacement. At step 305, the fasteners 71 of the identified wear pads 7 are removed from the panel plate 51. The identified wear pads 7 are then removed, and replaced with replacement wear pads 7 as shown at step 307. Subsequently, at step 309 the replacement wear pads 7 are then secured to the panel plate 51 with fasteners.

In some instances inspection and servicing may be performed in the vicinity of the respective fender assembly 1. However, to minimise down-time of the berth and berthing structure, it may be advantageous to quickly replace the removed identified panel with a spare. serviceable panel assembly 5 so that the berth may be used as soon as possible. In this instance the maintenance steps need not be carried out as part of the panel assembly replacement operation, but can conducted in a workshop at another time and location where it will not disrupt operation of the berths.

### Replacement of Panel Assembly

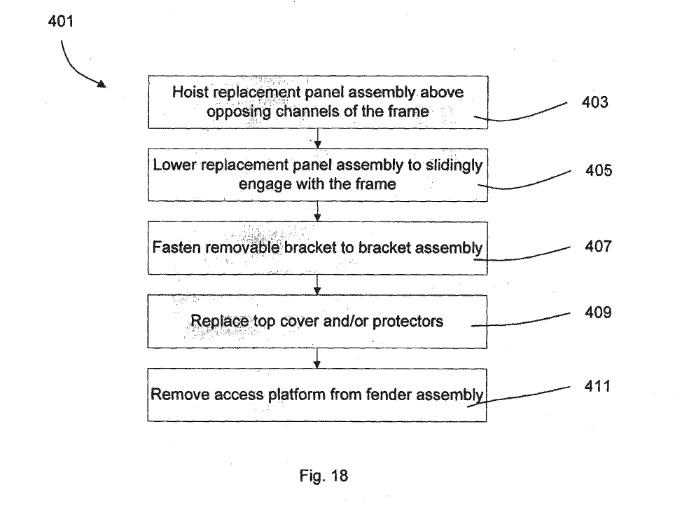

The steps for replacing a panel assembly 401 will now be described with reference to FIG. 18.

To replace the panel assembly 5, at step 403 the replacement panel assembly 5 is hoisted by the lifting lug 65 so that it is positioned vertically above the opposing channels 41 of the frame 3.

At step 405 the panel assembly 5, typically with the assistance of workers, is guided and lowered so the opposite edges 42 are received into the channels 41. Further lowering of the panel assembly 5 by the hoist allows the panel assembly 5 to slidingly engage into the desired position with respect to the frame 3. The stop 67 ensures the panel assembly 5 cannot be lowered past the desired position.

At step 407 the panel assembly 5 is further engaged with the frame by fastening the removable bracket 46 to the bracket assembly 43 to prevent movement of the panel assembly 5 relative to the frame.

At step 409 the top cover 73 and/or corner protectors are then replaced.

At step 411 the access platform 13 (if in use) is removed from the fender assembly 1, and the fender assembly 1 and berth may resume normal operation.

In one advantageous implementation, the removal and replacement of the panel assembly 5 may be performed during the downtime period of the berth between vessels leaving and entering the berth during a normal operation cycle. This minimises the disruption fender maintenance may have on vessel loading/unloading operations. Therefore to perform maintenance on a plurality of fender assemblies 1 on a pier, it may be advantageous to schedule maintenance on a small number of fender assemblies 1 during each downtime period, so that maintenance on the entire plurality of fender assemblies 1 would be spread over several cycles of vessels leaving and entering the berth.

### Removal and Replacement of Support Chains

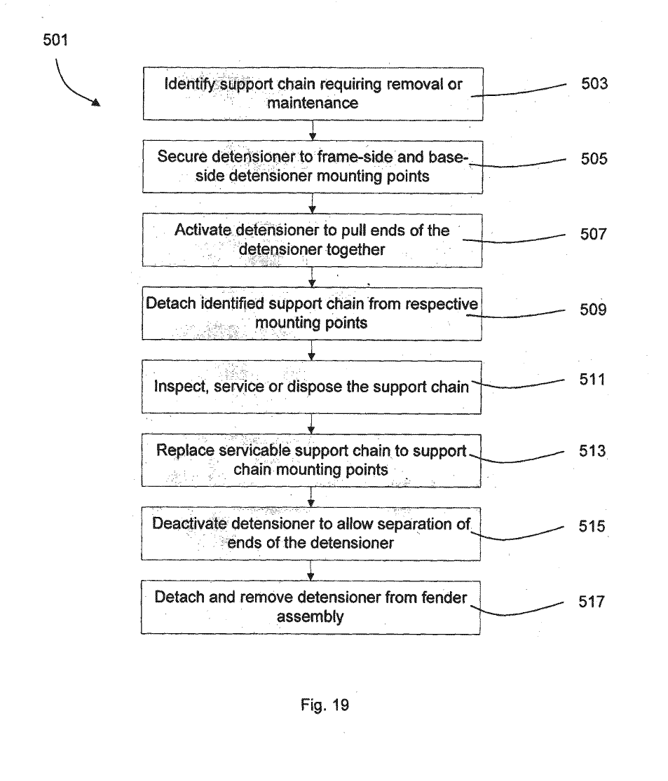

Turning to flowchart 501 FIG. 19 (and with reference to FIG. 8A), removal and replacement of the support chains 15 with the assistance of the detensioners 23 will now be described.

At step 503 a support chain 15 requiring maintenance or replacement is identified.

At step 505, the ends 159, 161 of the detensioner 23 are secured in the frame-side and base-side detensioner mounting points 25, 27.

At step 507 the detensioner 23 is then activated so that the length adjustable component 163 pulls the ends 159, 161 of the detensioner 23 together. As a result, the frame 3 is pulled by the detensioner towards the base 9, with the detensioner 23 itself in tension.

At step 509 the identified support chain 15 (now relieved of tension), is detached from respective support chain mounting points 19 and 21.

At step 511 the support chain 15 may be inspected, serviced or disposed.

To replace the support chain 15, a serviceable support chain is attached to the support chain mounting points 19, 21 at step 513.

At step 515 the installed detensioner is deactivated to allow separation of the ends 159, 161 of the detensioner 23. This reduces the tension in the detensioner 23 and allows the serviceable support chain 15 to take up tension. Ideally, though not essentially, the detensioner is deactivated by gradually reducing the force/pressure in the hydraulic cylinder of the length adjustable component 163 so that the decrease in tension in the detensioner 23 and consequential increase in tension of the support chain 15 occurs in a gradual controlled manner.

Once the serviceable support chain 15 is properly tensioned, the detensioner 23 is detached and removed from the fender assembly 1 at step 517.

### Advantages

An advantage of the disclosed embodiments is to allow servicing of the wear pads 7 without disassembly and removal of other components of the fender assembly such as the frame, or energy absorbing unit. By leaving the frame and other components in situ, less labour and machinery (and hence less time) is required to service the maritime fender assembly.

For example, maritime fender assemblies can be large devices with the frames weighing in the order of tonnes. By removing only the panels and associated pads, a smaller hoist having a smaller lifting capacity can be used. This can lead to faster set-up times for the hoist and other maintenance equipment such as the access platform. As the panels are relatively lighter and smaller, there is a reduced handling requirement. Such applications are also relevant for older berths that have limited weight restrictions on their offshore access jetties, thus making it impossible to transport a regular fender frame to shore for maintenance without the use of costly barges and floating crane vessels.

Another advantage may be obtained by scheduling fender maintenance between the period vessels leave and enter the dock. This would allow maintenance of the fender assemblies to be conducted without affecting or significantly affecting normal vessel operations at the berth.

The detensioners advantageously assist removal of the support chains by relieving tension in the support chains before removal. This allows easier removal of the support chains, and may improve the safety for workers who can avoid or minimise handling of the support chains that are under tension. The detensioners may also be advantageously used to assist in restoring tension in the support chains during installation.

### Variations

The engagement means 4 may comprise of a range of means to engage the panel assembly 5 to the frame 3. In one variation, the panel assemblies 5 may slide into engagement with the frame 3 along an axis perpendicular to the outwardly facing surface 33 of the frame 3.

In another variation, the panels 5 may slide into engagement with the frame 3 along a horizontal axis parallel to the outwardly facing surface 33.

The above described fender assembly 1 includes two panel assemblies 5 received by a single frame 3. Variations may include other combinations, including one panel assembly for each frame, or a plurality of panel assemblies 5 for each frame 3. In yet another variation, there may be provided one panel assembly engaged with two or more frames 3.

In one variation, the panel assemblies 5 may be a substantially monolithic component, such as a single piece of rubber with at least one outwardly facing surface as a wear pad.

In the embodiment described above, the fender element 11 is an elastomeric body which relies on deformation of the resilient material. However, it is to be appreciated the energy absorbing unit may be of other forms, such as a pressurised body (e.g. an “airbag”), a system of springs, pneumatic or hydraulic systems etc. Importantly, the fender element absorbs energy transmitted from the moveable frame 3, whilst allowing at least some displacement of the frame 3 relative to the base 9 and berthing structure.

Furthermore, the fender element 11 described above also functions to support at least part of the weight of the frame 3 and panels 5. Variations of the fender assembly may include other weight supporting elements so the frame 3 for the frame can be moveably mounted to the berthing structure. In such variations, the energy absorbing unit is not required to support the weight of the frame 3 or panels 5.

The detensioner 23 described above includes a hydraulic cylinder to pull the ends 159, 161 together. In variations of the detensioner, other forms of the length adjustable component 163 may be used, including a threaded jack, a ratchet system, pneumatic system etc.

It will be understood that the invention disclosed and defined in this specification extends to all alternative combinations of two or more of the individual features mentioned or evident from the text or drawings. All of these different combinations constitute various alternative aspects of the invention.

1. A method of maintaining a maritime fender assembly mounted to a berthing structure, the maritime fender assembly comprising:
a frame assembly for releasably receiving a substantially flat panel assembly, the panel assembly having at least one outwardly facing wear pad for contact with a vessel, the frame assembly comprising:
a pair of opposing channels into which the panel assembly is slidingly received, the pair of opposing channels being, in use, substantially vertical; and
a panel assembly securing means having a release configuration whereby the panel assembly is removable from the pair of opposing channels and an engaged configuration whereby the panel assembly is secured in the pair of opposing channels; and
a resilient fender element mounted between the frame assembly and the berthing structure, the resilient fender element for absorbing forces on the panel assembly and/or the frame assembly;
wherein the method comprises:
configuring the panel assembly securing means to the release configuration;
removing an existing panel assembly from the pair of opposing channels by sliding the existing panel assembly out of the pair of opposing channels;
positioning a serviceable panel assembly into the pair of opposing channels; and
configuring the panel assembly securing means to the engaged configuration to secure the serviceable panel assembly to the frame assembly,
wherein the method is performed while the frame assembly and fender element are maintained in situ mounted to the berthing structure.

2. A method according to claim 1, further comprising:
replacing one or more worn outwardly facing wear pads on an existing panel assembly with one or more serviceable outwardly facing wear pads to provide the serviceable panel assembly.

3. A method according to claim 1, wherein the panel assembly is slidingly received into the pair of opposing channels along a substantially vertical axis, and wherein:
removing the existing panel assembly from the pair of opposing channels comprises lifting the panel assembly in a substantially vertical direction, and
the step of positioning the serviceable panel assembly into the pair of opposing channels comprises lowering the serviceable panel assembly into the pair of opposing channels in a substantially vertical direction.

4. A method according to claim 1, wherein the frame assembly further comprises a stop means for assisting in positioning the panel assembly correctly within the pair of opposing channels, and wherein
positioning the serviceable panel assembly into the pair of opposing channels further comprises positioning the panel assembly against the stop means.

5. A method according to claim 1, wherein the panel assembly securing means comprises a bracket assembly comprising a first bracket fixed to the frame assembly and a second bracket removably securable to the first bracket, and wherein:
configuring the panel assembly securing means to the release configuration comprises releasing the second bracket from the first bracket; and
configuring the panel assembly securing means to the engaged configuration comprises securing the second bracket to the first bracket.

6. A method according to claim 1, wherein the fender assembly further comprises a release mechanism for facilitating separation of the panel assembly from the frame assembly, and wherein the method further comprises operating the release mechanism to separate the panel assembly from the frame assembly.

7. A method according to claim 6, wherein the release mechanism comprises a plate with a threaded aperture carried by the panel assembly, and wherein operating the release mechanism comprises screwing a screw through the threaded aperture so the screw bears against an engagement surface of the frame assembly and urges the panel assembly away from the frame assembly.

8. A method according to claim 1, wherein the panel assembly further comprises a lifting lug, and wherein the method further comprises attaching the lifting lug to a hoist for removal of the panel assembly from the frame.

9. A method according to claim 1, further comprising:
providing a maintenance platform at the maritime fender assembly; and
securing the maintenance platform to one or more maintenance platform mounts provided on the fender assembly.

10. A method according to claim 1, wherein the fender assembly further comprises:
a base mounted to the berthing structure, the fender element being mounted between the frame and the base;
one or more support chains, each support chain connected to and extending between a frame-side support chain mount provided on the frame and a base-side support chain mount provided on the base;
one or more frame-side detensioner mounts, each frame-side detensioner mount corresponding to a frame-side support chain mount; and
one or more base-side detensioner mounts, each base-side detensioner mount corresponding to a frame-side support chain mount; and wherein the method further comprises:
affixing a detensioner between a frame-side detensioner mount and a base-side detensioner mount;
activating the detensioner to draw the frame and base together, thereby detensioning a support chain,
removing the detensioned support chain from its respective frame-side and base-side support chain mounts;
affixing a serviceable support chain to the respective frame-side and base-side support chain mounts;
deactivating the detensioner; and
removing the detensioner from its frame-side and base-side detensioner mounts.

11. A maritime fender assembly for mounting to a berthing structure, the fender assembly comprising:
a substantially flat panel assembly having at least one outwardly facing wear pad for contact with a vessel;
a frame assembly for releasably receiving the panel assembly, the frame assembly comprising:
a pair of opposing channels into which the panel assembly is slidingly received, the pair of opposing channels being, in use, substantially vertical; and
a panel assembly securing means having a release configuration whereby the panel assembly is removable from the pair of opposing channels and an engaged configuration whereby the panel assembly is secured in the pair of opposing channels,
the fender assembly further comprising a resilient fender element mounted between the frame and the berthing structure, the resilient fender element being for absorbing forces on the panel assembly and/or the frame assembly.

12. A maritime fender assembly according to claim 11, wherein the frame assembly further comprises a stop means against which the panel assembly bears when the panel assembly is correctly received within the pair of opposing channels.

13. A maritime fender assembly according to claim 12, wherein when the panel assembly securing means is in the release configuration the panel assembly is removable from the frame assembly without requiring removal of the frame assembly or the resilient fender element from the berthing structure.

14. A maritime fender assembly according to claim 11, further comprising a release mechanism for facilitating separation of the panel assembly from the frame assembly.

15. A maritime fender assembly according to claim 14, wherein the release mechanism comprises an apertured plate carried by the panel assembly and which, when the panel assembly is received in the frame assembly, extends over the frame assembly such that an opening of the aperture faces an engagement surface of the frame.

16. A maritime fender assembly according to claim 15, wherein the aperture of the apertured plate receives a jacking means for, in use, bearing on the engagement surface of the frame assembly and jacking the panel assembly away from the frame.

17. A maritime fender assembly according to claim 16, wherein the panel assembly is removable from the frame by being slid along a removal axis, the engagement surface is substantially perpendicular to the removal axis, and wherein in use the jacking means bears on the engagement surface to urge the panel assembly in a direction substantially parallel to the removal axis.

18. A maritime fender assembly according to claim 15, wherein the aperture of the apertured plate is internally threaded and wherein the jacking means includes a screw receivable in the aperture.

19. A maritime fender assembly according to claim 11, wherein the panel assembly further comprises a lifting lug for attaching the panel assembly to a hoist.

20. A maritime fender assembly according to claim 11, wherein the panel assembly comprises a plurality of outwardly facing wear pads, and wherein the plurality of outwardly facing wear pads are releasably mounted to the panel assembly.

21. A maritime fender assembly according to claim 11, wherein the frame assembly receives two or more panel assemblies, each panel assembly received in a pair of opposing channels.

22. A maritime fender assembly according to claim 11, wherein the frame assembly further comprises one or more inner wear pads which face and bear against an inwardly facing surface of the panel assembly.

23. A maritime fender assembly according to claim 22, wherein the inner wear pads are manufactured from a low-friction material.

24. A maritime fender assembly according to claim 22, wherein the inner wear pads are visually distinct from the at least on outwardly facing wear pad of the panel assembly.

25. A maritime fender assembly according to claim 11, wherein the panel assembly securing means comprises a bracket assembly comprising:
a first bracket fixed to the frame assembly; and
a second bracket removably securable to the first bracket, and wherein
in the engaged configuration the second bracket is secured to the first bracket to retain the panel assembly in position in the frame assembly, and in the release configuration the second bracket is released from the first bracket to allow the panel assembly to be removed from the frame assembly.

26. A maritime fender assembly according to claim 25, wherein the first and second brackets are provided with one or more complementary pairs of apertures, and wherein the second bracket is secured to the first bracket by one or more bolts passing through the one or more complementary pairs of apertures.

27. A maritime fender assembly according to claim 11, wherein the fender assembly further includes one or more maintenance platform mounts for releasably securing a maintenance platform to the fender assembly.

28. A maritime fender assembly according to claim 11, wherein the frame assembly comprises a frame-side support chain connector for connecting a support chain to the frame assembly, and a frame-side detensioner connector corresponding to the frame-side support chain connector, the frame-side detensioner connector for receiving a support chain detensioner operable to detension the support chain to allow for its removal.

29. A maritime fender assembly according to claim 28, further including a base adapted to be mounted to the berthing structure, the fender element being mounted between the frame and the base, and wherein the base includes:
a base-side support chain connector for connecting a support chain between a corresponding frame-side support chain connector and the base, and
a base-side detensioner connector corresponding to the a base-side support chain connector, the base-side detensioner connector for connecting a support chain detensioner between a corresponding frame-side detensioner connector and the base, the support chain detensioner operable to detension the support chain to allow for its removal.

30. A maritime fender assembly for mounting to a berthing structure, the maritime fender assembly comprising:
a frame carrying at least one outwardly facing wear pad for contact with a vessel, the frame including at least one frame-side support chain mount and at least one frame-side detensioner mount;
a base mounted to the berthing structure, the base including at least one base-side support chain mount and at least one base-side detensioner mounts;
a resilient fender element mounted between the frame and base; and
one or more support chains connected to and extending between a base-side support chain mount and a corresponding frame-side support chain mount, wherein the at least one frame-side detensioner mount and at least one base-side detensioner mount include at least one corresponding pair of detensioner mounts, the or each corresponding pair of detensioner mounts positioned to connect a detensioner between, the detensioner actuable to detension at least one support chain.

31. A maritime fender assembly according to claim 30, wherein the one or more support chains includes a plurality of support chains, each support chain connected to and extending between a frame-side support chain mount and a corresponding base-side support chain mount, each support chain having a corresponding frame-side detensioner mount and a base-side detensioner mount for connecting a detensioner therebetween, the detensioner actuable to reduce tension in the support chain.

32. A method of maintaining a maritime fender assembly mounted to a berthing structure, the maritime fender assembly comprising:
a frame carrying at least one outwardly facing wear pad for contact with a vessel, the frame including at least one frame-side support chain mount and at least one frame-side detensioner mount;
a base mounted to the berthing structure, the base including at least one base-side support chain mount and at least one base-side detensioner mounts;
a resilient fender element mounted between the frame and base; and
one or more support chains connected to and extending between a base-side support chain mount and a corresponding frame-side support chain mount, wherein the method includes:
affixing a detensioner between a frame-side detensioner mount and a corresponding base-side detensioner mount;
activating the detensioner to draw the frame and base together, thereby detensioning a support chain,
removing the detensioned support chain from its respective frame-side and base-side support chain mounts;
affixing a serviceable support chain to the respective frame-side and base-side support chain mounts;
deactivating the detensioner; and
removing the detensioner from its frame-side and base-side detensioner mounts.
